(19) United States
(12) Patent Application Publication
(10) Pub. No.: US 2015/0198753 A1
(43) Pub. Date: Jul. 16, 2015

(54) FILM MIRROR

(71) Applicant: FUJIFILM Corporation, Tokyo (JP)

(72) Inventor: Naruhiko AONO, Kanagawa (JP)

(73) Assignee: FUJIFILM Corporation, Tokyo (JP)

(21) Appl. No.: 14/669,730

(22) Filed: Mar. 26, 2015

Related U.S. Application Data
(63) Continuation of application No. PCT/JP2013/074663, filed on Sep. 12, 2013.

(30) Foreign Application Priority Data
Sep. 28, 2012 (JP) 2012-217157

(51) Int. Cl. G02B 5/08; G02B 5/20

(52) U.S. Cl. CPC G02B 5/0808; G02B 5/208

(57) ABSTRACT

There is provided a film mirror having excellent weather resistance and flexibility. The film mirror includes a resin substrate, and a metal reflective layer, a diffusion preventive layer, and a surface protection layer laminated on the resin substrate in this sequence, in which the diffusion preventive layer has a layer obtained by performing either or both of heating process and light irradiation process on a precursor layer that is formed by using either or both of a metal alkoxide, which has an acryloyloxy group or a methacryloyloxy group, and a hydrolysis condensate of the metal alkoxide.

### CROSS-REFERENCE TO RELATED APPLICATIONS

This application is a Continuation of PCT International Application No. PCT/JP2013/074663 filed on Sep. 12, 2013, which claims priority under 35 U.S.C. §119(a) to Japanese Application No. 2012-217157 filed on Sep. 28, 2012. Each of the above application(s) is hereby expressly incorporated by reference, in its entirety, into the present application.

### BACKGROUND OF THE INVENTION

The present invention relates to a film mirror that can be suitably used for collecting solar light.

Solar light reflecting apparatuses are exposed to ultraviolet rays or heat of solar light, wind and rain, dust, and the like, and thus had conventionally been made of glass mirrors.

However, the use of glass mirrors has a problem of damage in transit or a problem of high construction cost due to high strength requirement for mirror stands.

In order to solve the problems, in recent years, a suggestion has been made to replace the glass mirror with a reflective sheet (film mirror) made of resin.

For example, JP 2012-47861 A discloses a film mirror having an inorganic gas barrier layer between the outermost layer on the light incidence side of a metal reflective layer and the metal reflective layer. The inorganic gas barrier layer is provided for the purpose of inhibiting transmission of gas molecules such as oxygen or water vapor, inhibiting corrosion/discoloration of the metal reflective layer, and improving the weather resistance thereof.

The document also discloses that the inorganic gas barrier layer is formed by a sol-gel method using a metal alkoxide represented by General formula (I). In General formula (I), each of R¹ and R² independently represents a hydrocarbon group such as an alkyl group.

MR²ₘ(OR¹)ₙ₋ₘ General formula (I)

### SUMMARY OF THE INVENTION

Meanwhile, in recent years, a demand for film mirrors which can be used under harsh conditions such as high-temperature and high-humidity has increased, resulting in requirement for further improvement in weather resistance. In addition, in order to stick a film mirror on a curved surface or a surface having a complicated shape, further improvement in flexibility thereof has been required.

With reference to JP 2012-47861 A, the present inventors formed an inorganic gas barrier layer by using a metal alkoxide having a hydrocarbon group such as a vinyl group and evaluated the weather resistance and the flexibility of a film mirror having the inorganic gas barrier layer. The result showed that either or both of the weather resistance and flexibility of the manufactured film mirror failed to meet the level currently required and needed further improvements.

The present invention has been made under the aforementioned current circumstances, and an object thereof is to provide a film mirror having excellent weather resistance and flexibility.

As a result of intensive research to achieve the above object, the present inventors found that if either or both of a metal alkoxide having a predetermined functional group and a hydrolysis condensate of the metal alkoxide are used, the above object can be achieved. Based on the finding, they accomplished the present invention.

That is, the present inventors found that the above object can be achieved by the following constitution.

(1) A film mirror including a resin substrate, and a metal reflective layer, a diffusion preventive layer, and a surface protection layer which are laminated on the resin substrate in this sequence, in which the diffusion preventive layer has a layer obtained by performing either or both of heating process and light irradiation process on a precursor layer that is formed by using either or both of a metal alkoxide, which has an acryloyloxy group or a methacryloyloxy group, and a hydrolysis condensate of the metal alkoxide.

(2) The film mirror described in (1), in which the metal alkoxide is a metal alkoxide represented by Formula (1) which will be described later.

(3) The film mirror described in (1) or (2), further including a primer layer between the resin substrate and the metal reflective layer, in which the primer layer is a layer obtained by performing either or both of heating process and light irradiation process on a layer containing a polymer having a polymerizable group and a functional group which interacts with a metal.

(4) The film mirror described in any one of (1) to (3), in which the metal reflective layer contains silver as a main component.

(5) The film mirror described in any one of (1) to (4), further including an adhesive layer between the diffusion preventive layer and the surface protection layer, in which the adhesive layer contains at least one kind of resin selected from the group consisting of epoxy-based resin, acryl-based resin, urethane-based resin, and silicone-based resin.

(6) The film mirror described in any one of (1) to (5) which is used for collecting solar light.

According to the present invention, it is possible to provide a film mirror having excellent weather resistance and flexibility.

### BRIEF DESCRIPTION OF THE DRAWINGS

FIG. 1 is a cross-sectional view showing a first embodiment of a film mirror of the present invention.

FIG. 2 is a cross-sectional view showing a second embodiment of the film mirror of the present invention.

FIG. 3 is a cross-sectional view showing a third embodiment of the film mirror of the present invention.

### DETAILED DESCRIPTION OF THE INVENTION

Hereinafter, preferable embodiments of the film mirror of the present invention will be described.

First, characteristics of the present invention compared to the conventional technique will be described.

One of the characteristics of the present invention is that either or both of a metal alkoxide having an acryloyloxy group or a methacryloyloxy group (hereinafter, these groups will also be collectively referred to as a “(meth)acryloyloxy group”), and a hydrolysis condensate of the metal alkoxide are used. More specifically, first, either or both of the metal alkoxide and the hydrolysis condensate thereof contain an alkoxy group, and as a result of a hydrolysis/condensation reaction, a precursor layer of a metal oxide is formed. Then, the precursor layer is treated by either or both of heating process and light irradiation process, whereby the (meth)acryloyloxy groups in the precursor layer undergo a polymerization reaction. As a result, a carbon-carbon bond is formed, thereby forming a diffusion preventive layer. Metal oxide portions in the diffusion preventive layer have a function of inhibiting penetration of gas molecules. Moreover, organic portions, which have the carbon-carbon bond generated as a result of the polymerization between (meth)acryloyloxy groups, are uniformly distributed in the diffusion preventive layer so as to form a network structure, and give flexibility to the diffusion preventive layer. In this way, in the diffusion preventive layer, the inorganic portions and the organic portions of the metal oxide are uniformly mixed together, resulting in intended effects.

### First Embodiment

Hereinafter, a first embodiment of the film mirror of the present invention will be described with reference to a drawing.

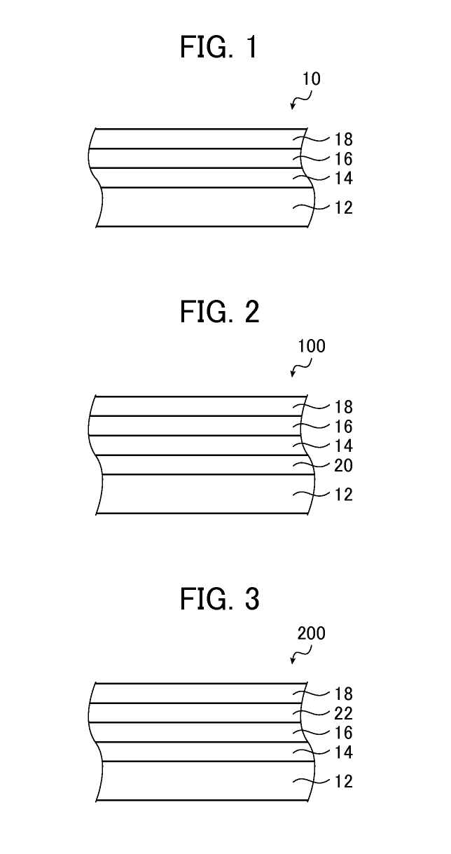

FIG. 1 is a cross-sectional view of the first embodiment of the film mirror of the present invention.

A film mirror 10 has a resin substrate 12, a metal reflective layer 14, a diffusion preventive layer 16, and a surface protection layer 18 laminated in sequence. Generally, light such as solar light enters the film mirror 10 from the surface protection layer 18 side and is reflected on the surface of the metal reflective layer 14.

Hereinafter, the respective layers constituting the film mirror 10 will be specifically described.

[Resin Substrate]

The type of the resin substrate 12 is not particularly limited as long as it is a resin substrate which gives flexibility to the film mirror 10 and can be laminated with the metal reflective layer 14 and the like.

Examples of materials forming the resin substrate 12 include polyolefin-based resins such as polyethylene and polypropylene; polyester-based resins such as polyethylene terephthalate and polyethylene naphthalate; polycarbonate-based resins; acryl-based resins such as polymethyl methacrylate; polyamide-based resins; polyimide-based resins; polyvinyl chloride-based resins; polyphenylene sulfide-based resins; polyether sulfone-based resins; polyethylene sulfide-based resins; polyphenylene ether-based resins; styrene-based resins; cellulose-based resins such as cellulose acetate; and the like.

Among these, polyester-based resins or acryl-based resins are preferable in terms of strong weather resistance of the film mirror.

The shape of the resin substrate 12 is planar. However, the shape is not particularly limited to the form shown in FIG. 1, and for example, it may be either concave or convex.

The thickness of the resin substrate 12 is not particularly limited because it depends on the shape of the resin substrate 12. However, when the resin substrate 12 has a planar shape as shown in FIG. 1, the thickness is preferably 25 μm to 300 μm in general.

[Metal Reflective Layer]

The metal reflective layer 14 is a layer disposed on the resin substrate 12, and has a function of reflecting light entering from the surface protection layer 18.

The material forming the metal reflective layer 14 is not particularly limited as long as it is a metal material reflecting visible light and infrared light, and specific examples thereof include silver, aluminum, and the like.

When silver or aluminum is used, the metal reflective layer 14 may contain other metals (for example, gold, copper, nickel, iron, and palladium) to an extent which does not influence the reflection properties thereof.

Particularly, in view of excellent reflectivity, the metal reflective layer 14 preferably contains silver as a main component. The “main component” means a component of the greatest content among all metal components constituting the metal reflective layer 14. More specifically, in a preferable embodiment, the main component content is equal to or greater than 90% by mass with respect to all metal components constituting the metal reflective layer 14.

The thickness of the metal reflective layer 14 is not particularly limited. However, in terms of reflectivity and the like, the thickness is preferably 50 nm to 500 nm, and more preferably 80 nm to 300 nm.

The method for forming the metal reflective layer 14 is not particularly limited, and either a wet method or a dry method can be adopted.

Examples of the wet method include methods known as so-called metal plating methods (electroless plating and electroplating).

Examples of the dry method include a vacuum deposition method, a sputtering method, an ion plating method, and the like.

[Diffusion Preventive Layer]

The diffusion preventive layer 16 is a layer disposed on the metal reflective layer 14. It is a layer which prevents corrosion/discoloration of the metal reflective layer 14 by preventing penetration of gas molecules such as oxygen or water vapor and prevents diffusion of metal ions deposited on the metal reflective layer 14.

The diffusion preventive layer 16 is a layer obtained by either or both of heating process and light irradiation process on a precursor layer formed with either or both of a metal alkoxide, which has an acryloyloxy group or a methacryloyloxy group, and a hydrolysis condensate of the metal alkoxide.

First, the metal alkoxide having an acryloyloxy group or a methacryloyloxy group, and the hydrolysis condensate of the metal alkoxide will be specifically described.

(Metal alkoxide having an acryloyloxy group or a methacryloyloxy group, and hydrolysis condensate of the metal alkoxide)

The metal alkoxide used in the present invention has an acryloyloxy group (—OCO—CH═CH₂) or a methacryloyloxy group (—OCO—C(CH₃)═CH₂). Herein, the metal alkoxide is a hydrolyzable organic metal compound having an alkoxy group.

The number of the acryloyloxy group and the methacryloyloxy group contained in the metal alkoxide is not particularly limited, but is generally 1 to 3 in many cases.

The metal alkoxide contains an alkoxy group. The number of carbon atoms contained in the alkoxy group is not particularly limited. However, in view of excellent handleability, the number of carbon atoms is preferably 1 to 3, and more preferably 1 to 2. Examples of the alkoxy group include a methoxy group, an ethoxy group, and the like.

A Portion of the alkoxy group contained in the metal alkoxide may be hydrolyzed to a hydroxyl group.

Furthermore, the metal alkoxide may contain a hydrolyzable group (for example, an isocyanate group, a halogen atom such as a chlorine atom, an oxyhalogen group, and an acetyl acetonate group) besides the alkoxy group, or may contain a non-hydrolyzable group besides the acryloyloxy group and the methacryloyloxy group.

The type of the metal atom contained in the metal alkoxide is not particularly limited, and examples thereof include a silicon atom (Si), an aluminum atom (Al), a lithium atom (Li), a zirconium atom (Zr), a titanium atom (Ti), a tantalum atom (Ta), a zinc atom (Zn), a barium atom (Ba), an indium atom (In), a tin atom (Sn), a lanthanum atom (La), an yttrium atom (Y), a niobium atom (Nb), and the like.

The hydrolysis condensate of the metal alkoxide means an oligomer (sol) obtained by a hydrolysis reaction and a condensation reaction of the metal alkoxide. A partial hydrolysis condensate which forms before the completion of hydrolysis reaction and the condensation reaction is also considered a hydrolysis condensate.

The method for manufacturing the hydrolysis condensate is not particularly limited, and examples thereof include known methods of hydrolysis reaction/condensation reaction. For example, a method of adding a metal alkoxide to a solvent, and if necessary, mixing with an acid catalyst (for example, hydrochloric acid or sulfuric acid and the like) or a base catalyst (for example, sodium hydroxide and the like) to cause a hydrolysis reaction/condensation reaction can be used.

The solvent used here is not particularly limited as long as it dissolves the metal alkoxide. Examples thereof include water; alcohol-based solvents such as methanol, ethanol, propanol, ethylene glycol, glycerine, and propylene glycol monomethyl ether; acids such as acetic acid; ketone-based solvents such as acetone, methyl ethyl ketone, and cyclohexanone; amide-based solvents such as formamide, dimethyl acetamide, and N-methylpyrrolidone; nitrile-based solvents such as acetonitrile and propionitrile; ester-bases solvents such as methyl acetate and ethyl acetate; carbonate-based solvents such as dimethyl carbonate and diethyl carbonate; aromatic hydrocarbon-based solvents such as benzene, toluene, and xylene; ether-based solvents; glycol-based solvents; amine-based solvents; thiol-based solvents; halogen-based solvents; and the like.

In view of better weather resistance and flexibility of the film mirror, examples of the metal alkoxide include a metal alkoxide represented by Formula (1).

(R₁-L₁-)ₙM(-OR₂)ₘ₋ₙ Formula (1)

In Formula (1), R₁ represents an acryloyloxy group or a methacryloyloxy group.

L₁ represents a single bond or a divalent linking group. Examples of the divalent linking group include a substituted or unsubstituted divalent aliphatic hydrocarbon group (preferably having 1 to 8 carbon atoms; for example, an alkylene group such as a methylene group, an ethylene group, or a propylene group); a substituted or unsubstituted divalent aromatic hydrocarbon group (preferably having 6 to 12 carbon atoms; for example, a phenylene group); —O—; —S—; —SO₂—; —N(R)— (R: an alkyl group); —CO—, —NH—, —COO—, —CONH—, a group as a combination of these (for example, an alkyleneoxy group, an alkyleneoxycarbonyl group, or an alkylene carbonyloxy group); and the like.

When L₁ is a single bond, R₁ is directly bonded to M.

R₂ represents an alkyl group.

The number of carbon atoms contained in the alkyl group is not particularly limited. However, in view of excellent handleability, the number of carbon atoms is preferably 1 to 4, and more preferably 1 to 3.

Examples of R₂ include a methyl group, an ethyl group, a propyl group, and the like.

M represents at least one kind of metal atom selected from the group consisting of a silicon atom, an aluminum atom, a germanium atom, a titanium atom, and a zirconium atom. Among these, in view of better weather resistance of the film mirror, a silicon atom is preferable.

m represents the valency of M. For example, when M is a trivalent metal atom such as an aluminum atom, m is 3. When M is a tetravalent metal atom such as a silicon atom, m is 4.

n represents a positive integer of 1 to (m−1).

When n is equal to or greater than 2, each R₁ may be the same as or different from each other.

Moreover, when (m−n) is equal to or greater than 2, each R₂ may be the same as or different from each other.

In Formula (1), when M is a silicon atom, and n is 1, the hydrolysis condensate of the metal alkoxide corresponds to so-called silsesquioxane. The silsesquioxane is a network-type of polymer having a repeating unit of (RSiO_{1.5}) obtained by a sol-gel reaction of a trifunctional silane compound.

In the aforementioned case, the hydrolysis condensate of the metal alkoxide corresponds to silsesquioxane having a repeating unit. The shape of the silsesquioxane used is not particularly limited, and examples thereof include a random shape, a cage shape, a ladder shape, and the like.

In view of better weather resistance and flexibility of the film mirror, a hydrolysis condensate of a metal alkoxide is preferably used, and particularly, a hydrolysis condensate of a metal alkoxide represented by Formula (1), in which M is a silicon atom and n is 1, is more preferably used.

The precursor layer is a layer to be treated by heating process and light irradiation process which will be described later, and is formed by using either or both of the aforementioned metal alkoxide and the hydrolysis condensate thereof. More specifically, by disposing either or both of the metal alkoxide and the hydrolysis condensate thereof on the metal reflective layer 14, and if necessary, performing a hydrolysis/condensation reaction (so-called sol-gel reaction), the precursor layer (a layer containing a metal oxide) is formed.

The method for forming the precursor layer is not particularly limited. For example, a method of coating the metal reflective layer 14 with a composition for forming a precursor layer which contains either or both of the metal alkoxide and the hydrolysis condensate thereof, and if necessary, drying the composition can be used.

If necessary, the composition for forming a precursor layer may contain a solvent. The solvent used is not particularly limited, and examples thereof include the solvents used for the hydrolysis reaction/condensation reaction of the metal alkoxide. Particularly, organic solvents are preferable since they make it easy to adjust the thickness of the precursor layer and are better in wet-spreading property on the metal reflective layer 14. Among the organic solvents, alcohol-based solvents (particularly, aliphatic lower alcohols such as methanol, ethanol, propanol, isopropanol, butanol, isobutanol, ethylene glycol, and propylene glycol) are more preferable.

The method for coating the metal reflective layer 14 with the composition for forming a precursor layer is not particularly limited. Specifically, it is possible to use known methods such as a coating method, an extrusion coating method, and a roll coating method using a spin coater, a double roll coater, a slit coater, an air knife coater, a wire bar coater, a slide hopper, a spray coater, a blade coater, a doctor coater, a squeeze coater, a reverse roll coater, a transfer roll coater, an extrusion coater, a curtain coater, a dip coater, a die coater, and a gravure roll.

At the time of forming the precursor layer, after the metal reflective layer 14 is coated with the composition for forming a precursor layer, if necessary, drying process may be performed to remove the solvent.

The conditions of the drying process are not particularly limited. However, it is preferable to perform heating process under a temperature condition which does not cause a polymerization reaction of the acryloyloxy group or the methacryloyloxy group. More specifically, the heating process is preferably performed for 0.5 hours to 30 hours (preferably for 1 hour to 10 hours) at 50° C. to 120° C. (preferably at 60° C. to 100° C.)

The thickness of the precursor layer is not particularly limited and can be adjusted according to the intended thickness of the diffusion preventive layer 16. Generally, the thickness is 0.5 μm to 2 μm in many cases.

The precursor layer is treated by either or both of heating process and light irradiation process. As the process performed on the precursor layer, either one of the heating process and the light irradiation process may be performed, or both of them may be performed. When both of them are to be performed, they may be performed separately as independent steps or performed simultaneously.

Upon the implementation of these processes, a polymerization reaction occurs between the acryloyloxy groups or between the methacryloyloxy groups, thereby forming carbon-carbon bonds, which give flexibility to the diffusion preventive layer 16.

As the conditions of the heating process, optimal conditions are selected according to the type of the metal alkoxide used. Particularly, it is preferable to perform the heating process for 0.1 hours to 3 hours (preferably for 0.5 hours to 2 hours) at 60° C. to 150° C. (preferably at 80° C. to 120° C.) since under such conditions, the crosslinking density of the diffusion preventive layer 16 is further increased, and the weather resistance and flexibility of the film mirror are further improved.

At the time of the heating process, a thermal polymerization initiator may be used. For example, the thermal polymerization initiator may be contained in the precursor layer. As the thermal polymerization initiator, it is possible to use a peroxide initiator such as benzoyl peroxide or azoisobutyronitrile, an azo-based initiator, and the like.

As the conditions of the light irradiation process, optimal conditions are selected according to the type of the metal alkoxide used. Particularly, the exposure amount is preferably 10 mJ/cm² to 8,000 mJ/cm² and more preferably 100 mJ/cm² to 3,000 mJ/cm², since under such conditions, the crosslinking density of the diffusion preventive layer 16 increases, and the weather resistance and flexibility of the film mirror are further improved.

At the time of the light irradiation process, a photopolymerization initiator may be used. For example, the photopolymerization initiator may be contained in the precursor layer. The photopolymerization initiator may be a low-molecular weight compound or a high-molecular weight compound, and a generally known photopolymerization initiator is used.

As the low-molecular weight photopolymerization initiator, for example, it is possible to use known photopolymerization initiators including acetophenones such as p-tert-butyl trichloroacetophenone, 2,2′-diethoxyacetophenone, and 2-hydroxy-2-methyl-1-phenylpropan-1-one; phosphine oxides such as 2,4,6-trimethylbenzoyl diphenyl phosphine oxide; benzophenones such as benzophenone and 4,4′-bisdimethylaminobenzophenone; benzyl ketals such as benzyl dimethyl ketal and hydroxycyclohexyl phenyl ketone; Michler's ketone; benzoyl benzoate; benzoins such as benzoin, benzoin methyl ether, benzoin isopropyl ether, and benzoin isobutyl ether; α-acyloxime ester; tetramethylthiuram monosulfide; trichloromethyl triazine; and thioxanthone such as 2-chlorothioxanthone, 2-methylthioxanthone, 2-ethylthioxanthone, and 2-isopropylthioxanthone. Besides, those generally being used as photoacid generators such as a sulfonium salt, an iodonium salt, or the like, function as a radical generator upon light irradiation, and thus may be used in the present invention. As the high-molecular weight photopolymerization initiator, it is possible to use the high-molecular weight compounds having an active carbonyl group on its side chain, as described in JP 9-77891 A and JP 10-45927, and the polymer with a polymerization initiating group bonded to its side chain in the form of a pendant, as described in JP 2004-161995 A. Specifically, the aforementioned polymer is a polymer having a functional group (polymerization initiating group), which has polymerization initiation ability, and a crosslinkable group on the side chain thereof, and the polymer chain thereof can be formed into immobilized form by a crosslinking reaction. Specific examples thereof include the polymers described in paragraphs [0011] to [0158] in JP 2004-161995 A. Furthermore, it is also possible to use high-molecular weight compounds having the aforementioned low-molecular weight photopolymerization initiator in the skeleton thereof.

The light source used for exposure is not particularly limited, and examples thereof include a mercury lamp, a metal halide lamp, a xenon lamp, a chemical lamp, a carbon arc lamp, and the like. Examples of radiation include electron beams, X-rays, ion beams, far infrared rays, and the like.

The thickness of the diffusion preventive layer 16 is not particularly limited. However, in view of better weather resistance and flexibility of the film mirror, the thickness thereof is preferably 0.1 μm to 10 μm, and more preferably 0.3 μm to 1 μm.

[Surface Protection Layer]

The surface protection layer 18 is a layer disposed on the diffusion preventive layer 16. Generally, as shown in the drawing, the surface protection layer 18 is disposed as the uppermost surface layer of the film mirror 10 so as to improve scratch resistance and antifouling properties of the surface of the film mirror 10.

The material constituting the surface protection layer 18 is not particularly limited as long as it has transparency for transmitting light. Examples of the material include resin, glass, ceramic, and the like. Among these, in view of excellent flexibility, resin is preferable. In other words, the surface protection layer is preferably a resin layer (resin protective layer).

Examples of the resin include curable resins (for example, photocurable resins such as urethane (meth)acrylate resin, polyester (meth)acrylate resin, silicone (meth)acrylate resin, and epoxy (meth)acrylate resin; and thermosetting resins such as phenol resin, urea resin, phenoxy resin, silicone resin, polyimide resin, diallyl phthalate resin, furan resin, bismaleimide resin, and cyanate resin) and thermoplastic resins (for example, phenoxy resin, polyether sulfone, polysulfone, and polyphenylene sulfone).

Among these, examples of a resin film forming the resin layer include a cellulose ester-based resin film, a polyester-based resin film, a polycarbonate-based resin film, a polyarylate-based film, a polysulfone (including polyether sulfone)-based resin film, a polyester-based resin film such as polyethylene terephthalate and polyethylene naphthalate, a polyethylene film, a polypropylene film, cellophane, a cellulose diacetate film, a cellulose triacetate film, a cellulose acetate propionate film, a cellulose acetate butyrate film, a polyvinylidene chloride film, a polyvinyl alcohol film, an ethylene vinyl alcohol film, a syndiotactic polystyrene-based film, a polycarbonate film, a norbornene-based resin film, a polymethylpentene film, a polyether ketone film, a polyether ketone imide film, a polyamide film, a fluorine-based resin film, a nylon film, an acryl-based resin film such as a polymethyl methacrylates film, and the like.

Among these, in view of weather resistance, a polycarbonate-based resin film, a polyester-based resin film, a norbornene-based resin film, an acryl-based resin film, a fluorine-based resin film, an olefin-based resin film, and the like are preferable. More specifically, a polyvinylidene fluoride (PVDF) film and a polymethyl methacrylate (PMMA) film are preferable, and a PMMA film is more preferable.

The thickness of the surface protection layer 18 is not particularly limited. However, in view of better weather resistance and flexibility of the film mirror, the thickness thereof is preferably 10 μm to 200 μm, and more preferably 25 μm to 100 μm.

The method for forming the surface protection layer 18 is not particularly limited. For example, it is possible to use a method of sticking a predetermined resin substrate on the diffusion preventive layer 16, and a method of photocuring by ultraviolet rays irradiation or thermosetting by heating after coating the diffusion preventive layer 16 with a thermosetting composition containing the aforementioned photocurable resin or thermosetting resin.

[Film Mirror]

The film mirror 10 is used for various purposes (for example, a reflection plate of a display, a reflective member for illumination, and a member for solar light such as a solar cell or solar thermal power generation). Particularly, the film mirror 10 can be suitably used for the purpose of collecting solar light (for solar light collection).

### Second Embodiment

Hereinafter, a second embodiment of the film mirror of the present invention will be described with reference to a drawing. FIG. 2 is a cross-sectional view of the second embodiment of the film mirror of the present invention.

A film mirror 100 includes the resin substrate 12, a primer layer 20, the metal reflective layer 14, the diffusion preventive layer 16, and the surface protection layer 18 laminated in this sequence.

The constitution of the film mirror 100 shown in FIG. 2 is the same as the constitution of the film mirror 10 shown in FIG. 1, except that the film mirror 100 includes the primer layer 20. Therefore, the same constituents are marked with the same reference numerals and the description thereof will be omitted. Hereinafter, the primer layer 20 will be mainly described in detail.

[Primer Layer]

The primer layer 20 is a layer disposed between the resin substrate 12 and the metal reflective layer 14 so as to improve the adhesiveness therebetween.

The primer layer 20 is a layer obtained by performing either or both of heating process and light irradiation process on a layer containing a polymer having a polymerizable group and a functional group which interacts with a metal.

Hereinafter, first, the polymer used will be specifically described, and then the procedure of forming the layer will be specifically described.

(Polymer having a functional group, which interacts with a metal, and a polymerizable group)

The polymer contains a functional group (hereinafter, also referred to as an “interacting group”), which interacts with a metal, and a polymerizable group. The interacting group is a group which interacts with the metal reflective layer 14, and plays a role of improving the adhesiveness between the metal reflective layer 14 and the primer layer 20. Upon treatment by either or both of the heating process and the light irradiation process which will be described later, the polymerizable group causes a crosslinking reaction and thus improves the strength of the primer layer 20, and also plays a role of improving the adhesiveness between the resin substrate 12 and the primer layer 20 by partially reacting with the resin substrate 12.

The polymerizable group can be any functional group which can form a chemical bond between the polymers or between the polymer and the resin substrate 12 when supplied with energy. Examples of the polymerizable group include a radically polymerizable group, a cationically polymerizable group, and the like. Among these, in view of reactivity, a radically polymerizable group is preferable.

Examples of the radically polymerizable group include a methacryloyl group, an acryloyl group, an itaconic acid ester group, a crotonic acid ester group, an isocrotonic acid ester group, a maleic acid ester group, a styryl group, a vinyl group, an acrylamide group, a methacrylamide group, and the like. Among these, a methacryloyl group, an acryloyl group, a vinyl group, a styryl group, an acrylamide group, and a methacrylamide group are preferable. Particularly, in view of radical polymerizability and versatility in synthesis, a methacryloyl group, an acryloyl group, an acrylamide group, and a methacrylamide group are more preferable, and in view of alkali resistance, an acrylamide group and a methacrylamide group are even more preferable.

The type of the interacting group is not particularly limited as long as it is a group which interacts with a metal. Examples thereof include nitrogen-containing functional groups such as an amino group, an amide group, an imide group, a urea group, a tertiary amino group, an ammonium group, an amidino group, a triazine ring, a triazole ring, a benzotriazole group, an imidazole group, an benzimidazole group, a quinoline group, a pyridine group, a pyrimidine group, a pyrazine group, a quinazoline group, a quinoxaline group, a purine group, a triazine group, a piperidine group, a piperazine group, a pyrrolidine group, a pyrazole group, an aniline group, a group having an alkylamine structure, a group having an isocyanuric structure, a nitro group, a nitroso group, an azo group, a diazo group, an azide group, a cyano group, and a cyanate group (R—O—CN); oxygen-containing functional groups such as an ether group, a hydroxyl group, a phenolic hydroxyl group, a carboxyl group, a carbonate group, a carbonyl group, an ester group, a group having a N-oxide structure, a group having a S-oxide structure, and a group having a N-hydroxy structure; sulfur-containing functional groups such as a thiophene group, a thiol group, a thiourea group, a thiocyanuric acid group, a benzothiazole group, a mercaptotriazine group, a thioether group, a thioxy group, a sulfoxide group, a sulfone group, a sulfite group, a group having a sulfoximine structure, a group having a sulfoxinium salt structure, a sulfonic acid group, and a group having a sulfonic acid ester structure; phosphorus-containing functional groups such as a phosphate group, a phosphoramide group, a phosphine group, and a group having a phosphoric acid ester structure; groups having a halogen atom such as chlorine and bromine; and the like. Moreover, salts of the functional groups that can form a salt structure can also be used.

Among these, ionic polar groups such as a carboxyl group, a sulfonic acid group, a phosphoric acid group, and a boronic acid group or non-dissociative functional groups such as an ether group and a cyano group are more preferable since these exhibit high polarity and high adsorption ability onto a metal.

The polymer preferably contains a unit (repeating unit) represented by the following Formula (2) and a unit represented by Formula (3) since such a polymer is more easily synthesized, and the adhesiveness of the metal reflective layer 14 is further improved.

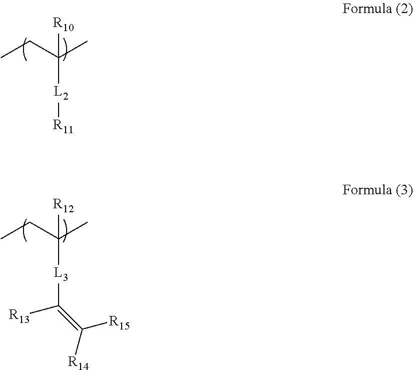

In Formula (2), R₁₀ represents a hydrogen atom or an alkyl group (for example, a methyl group or an ethyl group).

In Formula (2), L₂ represents a single bond or a divalent linking group. The divalent linking group has the same definition as the linking group represented by L₁ in the aforementioned Formula (1).

In Formula (2), R₁₁ represents an interacting group. The definition of the interacting group is as described above.

The polymer may contain two or more kinds of units represented by Formula (2) of different types of interacting group represented by R₁₁. For example, the polymer may contain a unit represented by Formula (2) in which R₁₁ is an ionic polar group and a unit represented by Formula (2) in which R₁₁ is a non-dissociative functional group.

In Formula (3), each of R₁₂ to R₁₅ independently represents a hydrogen atom or a substituted or unsubstituted alkyl group.

When each of R₁₂ to R₁₅ represents a substituted or unsubstituted alkyl group, an alkyl group having 1 to 6 carbon atoms is preferable, and an alkyl group having 1 to 4 carbon atoms is more preferable. More specifically, examples of the unsubstituted alkyl group include a methyl group, an ethyl group, a propyl group, and a butyl group, and examples of the substituted alkyl group include a methyl group, an ethyl group, a propyl group, and a butyl group which have been substituted with a methoxy group, a hydroxy group, a halogen atom (for example, a chlorine atom, a bromine atom, or a fluorine atom), and the like.

R₁₂ is preferably a hydrogen atom, a methyl group, or a methyl group which has been substituted with a hydroxy group or a bromine atom. R₁₃ is preferably a hydrogen atom, a methyl group, or a methyl group which has been substituted with a hydroxy group or a bromine atom. R₁₄ is preferably a hydrogen atom. R₁₅ is preferably a hydrogen atom.

In Formula (3), L₃ represents a single bond or a divalent linking group. The divalent linking group has the same definition as the linking group represented by L₁ in the aforementioned Formula (1).

The polymer most preferably includes a copolymer which contains a unit represented by Formula (A), a unit represented by Formula (B), and a unit represented by Formula (C), a copolymer which contains a unit represented by Formula (A) and a unit represented by Formula (B), a copolymer which contains a unit represented by Formula (A) and a unit represented by Formula (C), and the like.

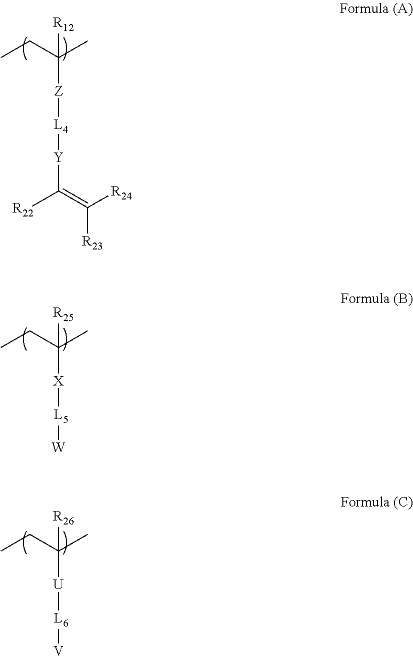

In Formulae (A) to (C), each of R₂₁ to R₂₆ independently represents a hydrogen atom or a substituted or unsubstituted alkyl group having 1 to 4 carbon atoms. Each of X, Y, Z, and U independently represents a single bond or a divalent linking group. Each of L₄, L₅, and L₆ independently represents a single bond or a divalent linking group. W represents a non-dissociative interacting group (non-dissociative functional group). V represents an ionic polar group. The definition of the linking group is as described above.

In the unit represented by Formula (A), it is preferable for each of Y and Z to independently represent an ester group, an amide group, or a phenylene group (—C₆H₄—). L₄ is preferably a substituted or unsubstituted divalent organic group (particularly, a hydrocarbon group) having 1 to 10 carbon atoms.

In the unit represented by Formula (B), W is preferably a cyano group or an ether group. Furthermore, both of X and L₅ are preferably single bonds.

In the unit represented by Formula (C), V is preferably a carboxylic acid group. Moreover, an embodiment is preferable in which V is a carboxylic acid group and there is a 4- to 8-membered ring structure at the linking site of L₆ and V. In addition, an embodiment is also preferable in which V is a carboxylic acid group and the chain length of LE consists of 6 to 18 atoms. Furthermore, in one of the preferable embodiments of the unit represented by Formula (C), V is a carboxylic acid group, and U and L₆ are single bonds. Among these, an embodiment is most preferable in which V is a carboxylic acid group, and both of U and L₆ are single bonds.

The amount of the units represented by Formulae (A) Formula (C) contained in the polymer is within the following range.

In other words, in the case of the copolymer which contains the unit represented by Formula (A), the unit represented by Formula (B), and the unit represented by (C), the ratio of unit represented by (A):unit represented by Formula (B):unit represented by Formula (C) is preferably 5 mol % to 50 mol %:5 mol % to 40 mol %:20 mol % to 70 mol %, and more preferably 10 mol % to 40 mol %:10 mol % to 35 mol %:20 mol % to 60 mol %.

In the case of the copolymer which contains the unit represented by Formula (A) and the unit represented by Formula (B), the ratio of unit represented by Formula (A):unit represented by Formula (B) is preferably 5 mol % to 50 mol %:50 mol % to 95 mol %, and more preferably 10 mol % to 40 mol %:60 mol % to 90 mol %.

In the case of the copolymer which contains the unit represented by Formula (A) and the unit represented by Formula (C), the ratio of unit represented by Formula (A):unit represented by Formula (C) is preferably 5 mol % to 50 mol %:50 mol % to 95 mol %, and more preferably 10 mol % to 40 mol %:60 mol % to 90 mol %.

Within the above range, the polymerization properties of the polymer are improved by the heating process or the light irradiation process, the resistivity of the primer layer is reduced, and the moisture-resistant adhesion is improved.

The method for forming the layer containing the aforementioned polymer is not particularly limited, and known methods can be adopted. For example, a method of coating the resin substrate 12 with a composition for forming a layer, which contains the polymer, and if necessary, drying the coating composition so as to form the layer can be used.

The layer containing the polymer is treated by either or both of heating process and light irradiation process. As process performed on the layer containing the polymer, either one of the heating process and the light irradiation process may be performed, or both of them may be performed. When both of them are to be performed, they may be performed separately as independent steps or performed simultaneously.

By performing these process, the polymerizable group is activated, and a reaction occurs between the polymerizable groups and between the polymerizable group and the resin substrate 12, whereby the adhesiveness between the resin substrate 12 and the primer layer 20 is improved.

As the conditions of the heating process, optimal conditions are selected according to the type of the polymer used. Particularly, the heating process is preferably performed for 0.1 hours to 3 hours (preferably for 0.5 hours to 2 hours) at 60° C. to 150° C. (preferably at 80° C. to 120° C.), since under such conditions, the crosslinking density of the primer layer 20 is increased, and the weather resistance and flexibility of the film mirror are further improved.

As the conditions of the light irradiation process, optimal conditions are selected according to the type of the polymer in use. Particularly, the exposure amount is preferably 10 mJ/cm² to 8,000 mJ/cm² and more preferably 100 mJ/cm² to 3,000 mJ/cm², since under such conditions, the crosslinking density of the primer layer 20 is increased, and the weather resistance and flexibility of the film mirror are further improved.

The light source for exposure is not particularly limited, and examples thereof include a mercury lamp, a metal halide lamp, a xenon lamp, a chemical lamp, a carbon arc lamp, and the like. Examples of radiation include electron beams, X-rays, ion beams, far infrared rays, and the like.

The thickness of the primer layer 20 is not particularly limited. However, in view of better weather resistance and flexibility of the film mirror, the thickness is preferably 0.05 μm to 10 μm, and more preferably 0.3 μm to 5 μm.

In the second embodiment, when the metal reflective layer 14 is formed on the primer layer 20, it is preferable to perform a catalyst providing step of providing a plating catalyst or a precursor thereof to the primer layer 20, and a plating step of performing plating process on the primer layer 20 provided with the plating catalyst or the precursor thereof. The metal reflective layer 14 formed by performing these steps exhibits better adhesiveness towards the primer layer 20. That is, the primer layer 20 functions as an undercoat layer of plating.

Hereinafter, the procedure of each of the steps will be specifically described.

(Catalyst Providing Step)

The catalyst providing step is a step of providing a plating catalyst or a precursor thereof to the primer layer 20. In this step, the interacting group in the primer layer 20 adsorbs the plating catalyst or the precursor thereof provided according to the function thereof. For example, when a metal ion is used as the precursor of the plating catalyst, the metal ion is adsorbed onto the primer layer 20.

Examples of the plating catalyst or the precursor thereof include those functioning as a catalyst or an electrode for plating in a plating step which will be described later. Therefore, the plating catalyst or the precursor thereof is determined according to the type of plating in the plating step.

Hereinafter, the plating catalyst or the precursor thereof used (particularly, an electroless plating catalyst or a precursor thereof) will be specifically described.

As the electroless plating catalyst, any species can be used as long as it functions as an active nucleus at the time of electroless plating. Specifically, examples thereof include metals of catalytic ability to cause an autocatalytic reduction reaction (those known as metals of an ionization tendency equal to or smaller than that of Ni and can be subjected to electroless plating), such as Pd, Ag, Cu, Ni, Al, Fe, Co, and the like, in particular. Among these, metals capable of polydentate coordination are preferable, and particularly, Pd is preferable since this metal can be coordinated to various types of functional groups and has a high level of catalytic ability.

As the precursor of the electroless plating catalyst, any species can be used without particular limitation as long as it can turn into the electroless plating catalyst by a chemical reaction. As the precursor, metal ions of the metals mentioned above as the examples of electroless plating catalyst are mainly used. By a reduction reaction, a metal ion as the precursor of an electroless plating catalyst turns into a zero-valent metal as an electroless plating catalyst. The metal ion as the precursor of an electroless plating catalyst may be provided to the primer layer and then changed to a zero-valent metal by a reduction reaction performed separately before the primer layer is immersed into an electroless plating bath, such that the metal ion turns into an electroless plating catalyst. Alternatively, the precursor of an electroless plating catalyst may be directly immersed into an electroless plating bath and converted to a metal (an electroless plating catalyst) by a reductant in the electroless plating bath.

The metal ion as the precursor of an electroless plating catalyst is preferably provided to the primer layer 20 by using a metal salt. The metal salt used is not particularly limited as long as it dissociates into a metal ion and a base (an anion) by dissolving in an appropriate solvent. Examples thereof include M(NO₃)ₙ, MClₙ, M_{2/n}(SO₄), M_{3/n}(PO₄)Pd(OAc)ₙ (M represents an n-valent metal atom), and the like. As the metal ion, those obtained by the dissociation of the metal salt can be suitably used. Specific examples thereof include Ag ion, Cu ion, Al ion, Ni ion, Co ion, Fe ion, and Pd ion. Among these, ion capable of polydentate coordination is preferable, and particularly, Ag ions, Cu ions, and Pd ions are preferable since these can be coordinated to various types of functional groups and have an excellent catalytic ability.

In the case of reducing the precursor of the electroless plating catalyst before the plating step, a catalyst activating solution (reducing solution) can be prepared, and a reducing step can be separately performed before the electroless plating. In many cases, the catalyst activating solution contains a reductant, which can reduce the precursor (mainly, a metal ion) of the electroless plating catalyst into a zero-valent metal, and a pH regulating agent for activating the reductant.

The concentration of the reductant in the entire solution is preferably 0.1% by mass to 50% by mass, and more preferably 1% by mass to 30% by mass.

As the reductant, it is possible to use boron-based reductants such as sodium borohydride and dimethylamine borane and reductants such as formaldehyde and hypophosphoric acid.

Particularly, the precursor is preferably reduced in an aqueous alkali solution containing formaldehyde.

As the plating catalyst, catalysts used for directly performing electroplating without performing electroless plating may also be used. Examples of such catalysts include zero-valent metals, and more specifically, the examples thereof include Pd, Ag, Cu, Ni, Al, Fe, Co, and the like. Among these, metals capable of polydentate coordination are preferable, and particularly, Pd, Ag, and Cu are preferable since these are excellently adsorbed onto (adhere to) the interacting group and have a high degree of catalytic ability.

The plating catalyst or the precursor thereof may be provided to the primer layer 20 by a method of preparing a solution containing the plating catalyst or the precursor thereof (for example, a dispersion obtained by dispersing a metal in an appropriate dispersion medium or a solution containing a metal ion obtained by dissociation of a metal salt dissolved in an appropriate solvent), and coating the primer layer 20 with the dispersion or the solution, or immersing the resin substrate 12 on which the primer layer 20 has been formed into the dispersion or the solution.

(Plating Step)

The plating step is a step of forming the metal reflective layer 14 by performing plating process on the primer layer 20 provided with the plating catalyst or the precursor thereof.

Examples of the type of plating performed in this step include electroless plating and electroplating. According to the function of the plating catalyst or the precursor thereof provided to the primer layer 20 in the catalyst providing step, the type of plating can be appropriately selected. That is, in this step, the primer layer 20 provided with the plating catalyst or the precursor thereof may be treated by either electroplating or electroless plating.

Hereinafter, the plating process suitably performed in this step will be described.

The electroless plating refers to an operation of causing deposition of a metal by a chemical reaction by using a solution in which metal ions to be deposited as plating are dissolved.

In the electroless plating, for example, the resin substrate 12 including the primer layer 20 provided with the electroless plating catalyst is washed with water so as to remove the excess electroless plating catalyst (a metal), and then immersed into an electroless plating bath. As the electroless plating bath used, known electroless plating baths can be utilized.

When the resin substrate 12 including the primer layer 20 provided with the precursor of the electroless plating catalyst is immersed into the electroless plating bath in a state in which the primer layer 20 has adsorbed or has been impregnated with the precursor of the electroless plating catalyst, it is preferable that the substrate is washed so as to remove the excess precursor (a metal salt or the like) before being immersed into the electroless plating bath. In this case, in the electroless plating bath, the precursor of the plating catalyst is reduced, and then the electroless plating is performed. As the electroless plating bath used at this time, as described above, known electroless plating baths can also be utilized.

In this step, when the plating catalyst or the precursor thereof provided has a function as an electrode, electroplating can be performed on the primer layer 20 provided with the plating catalyst or the precursor thereof.

In the present invention, as the method of electroplating, conventionally known methods can be used. Examples of metals used in the electroplating of the present step include copper, chromium, lead, nickel, gold, silver, tin, zinc, and the like. Among these, in view of reflectivity, silver is preferable.

Furthermore, after the aforementioned electroless plating, by using the formed plating film as an electrode, electroplating may be further performed.

Examples of silver compounds used for plating include silver nitrate, silver acetate, silver sulfate, silver carbonate, silver methanesulfonate, silver ammonia, silver cyanide, silver thiocyanate, silver chloride, silver bromide, silver chromate, silver chloranilate, silver salicylate, silver diethyldithiocarbamate, silver p-toluenesulfonate, and the like. Among these, in view of smoothness or the influence on the environment, silver methanesulfonate is preferable.

### Third Embodiment

Hereinafter, a third embodiment of the film mirror of the present invention will be described with reference to a drawing. FIG. 3 is a cross-sectional view of the third embodiment of the film mirror of the present invention.

A film mirror 200 includes the resin substrate 12, the metal reflective layer 14, the diffusion preventive layer 16, an adhesive layer 22, and the surface protection layer 18 laminated in this sequence.

The constitution of the film mirror 200 shown in FIG. 3 is the same as the constitution of the film mirror 10 shown in FIG. 1, except that the film mirror 200 includes the adhesive layer 22. Therefore, the same constituents are marked with the same reference numerals and the description thereof will be omitted. Hereinafter, the adhesive layer 22 will be mainly described in detail.

The adhesive layer 22 is a layer disposed between the diffusion preventive layer 16 and the surface protection layer 18 so as to improve the adhesiveness of the surface protection layer 18.

The type of adhesive used for the adhesive layer 22 is not particularly limited as long as the adhesive satisfies adhesiveness or smoothness. Specific examples thereof include silicone-based resins, urethane-based resins, polyester-based resins, acryl-based resins, melamine-based resins, epoxy-based resins, polyamide-based resins, vinyl chloride-based resins, vinyl chloride-vinyl acetate copolymer-based resins, and the like. One kind of these may be used alone, or two or more kinds thereof may be used in combination.

Among these, in view of weather resistance, epoxy-based resins, acryl-based resins, urethane-based resins, or silicone-based resins are preferable.

In view of adhesiveness, smoothness, reflectivity, and the like, the thickness of the adhesive layer is preferably 0.01 μm to 5 μm, and more preferably 0.1 μm to 2 μm.

The method for forming the adhesive layer is not particularly limited, and it is possible to use conventionally known coating methods, such as a gravure coating method, a reverse coating method, a die coating method, and methods using a blade coater, a roll coater, an air knife coater, a screen coater, a bar coater, a curtain coater, and the like.

### EXAMPLES

Hereinafter, the present invention will be more specifically described based on examples. However, the present invention is not limited thereto.

### Example 1

A PET support (A4300, manufactured by TOYOBO CO., LTD.) was coated with a solution containing an acrylic polymer represented by Formula (A) to a thickness of 0.5 μm by a spin coating method, and dried for 5 minutes at 80° C., thereby obtaining a coating film.

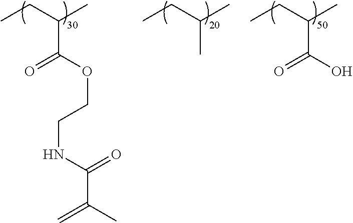

The acrylic polymer represented by Formula (A) was synthesized by the following method.

### Synthesis Example

1 L of ethyl acetate and 159 g of 2-aminoethanol were put into a 2 L three-neck flask and cooled in an ice bath. Then, 150 g of 2-bromoisobutyric acid bromide was added dropwise to adjust the internal temperature of the flask to be equal to or less than 20° C. Thereafter, the internal temperature was increased to room temperature (25° C.), and a reaction was performed for 2 hours. After the reaction was completed, 300 mL of distilled water was added thereto so as to stop the reaction. Subsequently, the ethyl acetate layer was washed 4 times with 300 mL of distilled water and then dried with magnesium sulfate, and further, ethyl acetate was removed by distillation, thereby obtaining 80 g of a raw material A.

Next, 47.4 g of the raw material A, 22 g of pyridine, and 150 mL of ethyl acetate were put into a 500 mL three-neck flask and cooled in an ice bath. Then, 25 g of acrylic acid chloride was added thereto dropwise to adjust the internal temperature of the flask to be equal to or less than 20° C. Subsequently, the internal temperature was increased to room temperature, and a reaction was performed for 3 hours. After the reaction was completed, 300 mL of distilled water was added thereto so as to stop the reaction. Then, the ethyl acetate layer was washed 4 times with 300 mL of distilled water and dried with magnesium sulfate, and further, ethyl acetate was removed by distillation. Thereafter, by column chromatography, 20 g of purified monomer M1 as shown below was obtained.

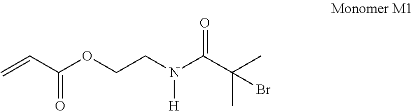

8 g of N,N-dimethylacetamide was put into a 500 mL three-neck flask and heated to 65° C. in a nitrogen gas stream. To the flask, 8 g of N,N-dimethylacetamide solution mixed with 14.3 g of monomer M1 obtained above, 3.0 g of acrylonitrile (manufactured by TOKYO CHEMICAL INDUSTRY CO., LTD.), 6.5 g of acrylic acid (manufactured by TOKYO CHEMICAL INDUSTRY CO., LTD.), and 0.4 g of V-65 (manufactured by Wako Pure Chemical Industries, Ltd.) were added dropwise over 4 hours. After the dropwise addition was completed, the solution was stirred for 3 hours, and then, 41 g of N,N-dimethylacetamide was added thereto, and the reaction solution was cooled to room temperature. To the reaction solution, 0.09 g of 4-hydroxy TEMPO (manufactured by TOKYO CHEMICAL INDUSTRY CO., LTD.) and 54.8 g of DBU were added, and a reaction was performed for 12 hours at room temperature. Thereafter, 54 g of a 70% by mass aqueous solution of methanesulfonic acid was added to the reaction solution. After the reaction was completed, reprecipitation was performed in water, and solids were collected, thereby obtaining 12 g of an acrylic polymer (a weight-average molecular weight of 53,000) represented by Formula (A).

A solution of the acrylic polymer represented by Formula (A) was prepared by the following method.

The acrylic polymer represented by Formula (A), 1-methoxy-2-propanol, and water were mixed together at a ratio of 7 parts by mass:74 parts by mass:19 parts by mass, respectively. Thereafter, a photopolymerization initiator (Esacure KTO-46, manufactured by Lamberti S.p.A, 0.35 parts by mass) was then added and mixed with the mixed solution by stirring.

Subsequently, by using a UV exposure machine (model number: UVF-502S, lamp: UXM-501MD) manufactured by SAN-EI ELECTRIC CO., LTD., the coating film obtained as above was irradiated by light at a wavelength of 254 nm at a cumulative exposure amount of 1,000 mJ/cm², thereby manufacturing a primer layer (thickness: 500 nm).

The obtained PET support with the primer layer (resin substrate with the primer layer) was immersed into a 1 wt % aqueous solution of sodium hydrogen carbonate for 5 minutes, and then washed with pure water.

Next, the resin substrate with the primer layer was immersed into a 1 wt % aqueous solution of silver nitrate for 5 minutes and then washed with pure water, thereby providing the precursor (silver ion) of the electroless plating catalyst to the resin substrate.

Then, the resin substrate with the primer layer was immersed into an aqueous alkali solution (pH 12, corresponding to a reductant) containing 40 mmol/L of NaOH and 2.2% by weight of formalin and then washed with pure water, thereby providing a metal to the primer layer.

Subsequently, the primer layer provided with the reduced metal was treated by electroplating process as below, thereby manufacturing a metal reflective layer (thickness: 100 nm).

As the electroplating solution, Dain Silver Bright PL50 (manufactured by Daiwa Fine Chemicals Co., Ltd.) was used, and pH thereof was adjusted to 9.0 with 8M potassium hydroxide. The resin substrate with the primer layer having the reduced metal on the surface thereof was immersed into the electroplating solution so as to be plated for 20 seconds at 0.5 A/dm², and was washed with flowing pure water for 1 minute.

As post treatment of electroplating, the resin substrate with the primer layer undergone plating was immersed in a 10% by mass aqueous solution of Dain Silver ACC (manufactured by Daiwa Fine Chemicals Co., Ltd.) for 90 seconds, and then washed with flowing pure water for 1 minute.

In this way, a laminate having a silver-containing reflective layer except in the edges of the PET support was obtained.

The metal reflective layer was coated with a composition X for forming a diffusion preventive layer which was obtained by dissolving random-shaped and cage-shaped silsesquioxane having a methacryloyloxy group (MAC-SI-20, manufactured by TOAGOSEI CO., LTD.) and a photopolymerization initiator (Irgacure 184, content: 1 wt % with respect to the silsesquioxane) in isopropyl alcohol, and underwent drying process for 5 minutes at 80° C., thereby obtaining a coating film (a precursor layer). Thereafter, by using a UV exposure machine (manufactured by GS Yuasa Corporation, a metal halide lamp), CV exposure (exposure amount: 800 mJ/cm²) was performed on the coating film, thereby manufacturing a diffusion preventive layer (thickness: 500 nm).

Herein, the laminate having the diffusion preventive layer manufactured as above on the uppermost surface layer thereof is referred to as a laminate X.

Next, the diffusion preventive layer of the laminate X was coated with a urethane adhesive (manufactured by TOYO INK CO., LTD., trade name: LIS 825, LCR 901), and underwent drying process for 5 minutes, thereby manufacturing an adhesive layer (thickness: 10 μm).

Subsequently, as a resin protective layer, a PMMA substrate (manufactured by Mitsubishi Rayon Co., Ltd., HBS 002, thickness: 75 μm) was stuck on the adhesive layer, thereby manufacturing a film mirror.

(Evaluation of Flexibility)

The laminate X (a laminate having a PET support, a primer layer, a metal reflective layer, and a diffusion preventive layer laminated in this sequence) was wrapped around a mandrel, and thus cracks generated were evaluated by visual inspection. The evaluation was performed according to the following criteria. The results are summarized in Table 1.

“A”: no crack was observed.

“B”: cracks were observed.

(Evaluation of Weather Resistance)

The manufactured film mirror was disposed in a xenon lamp light fastness tester (manufactured by Atlas Material Testing Solutions, Ci 5000, power: 180 W, Black Panel Temperature: 83° C.) and left under conditions of a temperature of 55° C. and a humidity of 40% RH for 500 hours. At this time, a rate of decrease in reflectivity (reflectivity (%) before minus reflectivity (%) after) of the film mirror at a wavelength of 450 nm was measured. For measuring the reflectivity, an ultraviolet/visible/near infrared spectrophotometer UV-3100 (manufactured by Shimadzu Corporation) was used, and the evaluation was performed according to the following criteria. The results are summarized in Table 1. For practical use, the rating A is preferable.

“A”: less than 2%

“B”: equal to or greater than 2% and less than 5%

“C”: equal to or less than 5%

### Example 2

A film mirror was manufactured and evaluated in terms of the respective items according to the same procedure as in Example 1, except that an epoxy adhesive (manufactured by Pelnox Limited, trade name: ME 106, MU 636) was used instead of the urethane adhesive. The results are shown in Table 1.

### Example 3

A film mirror was manufactured and evaluated in terms of the respective items according to the same procedure as in Example 1, except that an acryl adhesive (manufactured by Soken Chemical & Engineering Co., Ltd., trade name: SK 2057) was used instead of the urethane adhesive. The results are shown in Table 1.

### Example 4

A film mirror was manufactured and evaluated in terms of the respective items according to the same procedure as in Example 1, except that random-shaped and cage-shaped silsesquioxane having an acryloyloxy group (AC-SI-20, manufactured by TOAGOSEI CO., LTD.) was used instead of the random-shaped and cage-shaped silsesquioxane having a methacryloyloxy group (MAC-SI-20, manufactured by TOAGOSEI CO., LTD.). The results are shown in Table 1.

### Comparative Example 1

A film mirror was manufactured and evaluated in terms of the respective items according to the same procedure as in Example 1, except that a diffusion preventive layer was not formed. The results are shown in Table 1.

### Comparative Example 2

A film mirror was manufactured and evaluated in terms of the respective items according to the same procedure as in Example 1, except that a composition Y for forming a diffusion preventive layer was used instead of the composition X for forming a diffusion preventive layer. The composition Y was prepared by mixing a hydrolysis condensate, which is obtained by dissolving vinyl ethoxy silane (manufactured by Shin-Etsu Silicones) in acetic acid/water/ethanol (mixing ratio=10/10/80) and heating the mixture for 4 hours at 60° C., with photo-initiator Irgacure 184 in an amount of lwt % of the hydrolysis condensate. The results are shown in Table 1.

The hydrolysis condensate used in Comparative example 2 did not contain an acryloyloxy group and a methacryloyloxy group.

TABLE 1

| | | Adhesive | Weather | Flexi- |
|---|---|---|---|---|
| | Metal alkoxide | layer | resistance | bility |
| Example 1 | Silsesquioxane having | Urethane | A | A |
| | methacryloyloxy group | resin | | |
| Example 2 | Silsesquioxane having | Epoxy | A | A |
| | methacryloyloxy group | resin | | |
| Example 3 | Silsesquioxane having | Acrylic | A | A |
| | methacryloyloxy group | resin | | |
| Example 4 | Silsesquioxane having | Urethane | A | A |
| | acryloyloxy group | resin | | |
| Comparative | — | Urethane | C | A |
| example 1 | | resin | | |
| Comparative | Hydrolysis condensate of | Urethane | B | B |
| example 2 | vinyl triethoxy silane | resin | | |

As shown in Table 1, the film mirror of the present invention has excellent weather resistance and flexibility.

In contrast, although Comparative example 1 without the diffusion preventive layer exhibits flexibility, the reflectivity thereof was degraded due to light irradiation, and weather resistance thereof was poor.

Furthermore, Comparative example 2, in which a hydrolysis condensate of vinyl triethoxy silane free of acryloyloxy group and methacryloyloxy group was used, was poorer than examples in terms of both weather resistance and flexibility. Comparative example 2 was particularly poor in terms of flexibility.

What is claimed is:

1. A film mirror comprising:
a resin substrate; and
a metal reflective layer, a diffusion preventive layer, and a surface protection layer which are laminated on the resin substrate in this sequence,
wherein the diffusion preventive layer has a layer obtained by performing either or both of heating process and light irradiation process on a precursor layer that is formed by using either or both of a metal alkoxide, which has an acrylcyloxy group or a methacryloyloxy group, and a hydrolysis condensate of the metal alkoxide.

2. The film mirror according to claim 1,
wherein the metal alkoxide is a metal alkoxide represented by Formula (1),
(R₁-L₁-)ₙM(-OR₂)ₘ₋ₙ, Formula (1)
(in Formula (1), R₁ represents an acryloyloxy group or a methacryloyloxy group; L₁ represents a single bond or a divalent linking group; R₂ represents an alkyl group; M represents at least one kind of metal atom selected from the group consisting of a silicon atom, an aluminum atom, a germanium atom, a titanium atom, and a zirconium atom; m represents the valency of M; n represents a positive integer of 1 to (m−1); when n is equal to or greater than 2, each of R₁ may be the same as or different from each other; and when (m−n) is equal to or greater than 2, each of R₂ may be the same as or different from each other.)

3. The film mirror according to claim 1, further comprising a primer layer between the resin substrate and the metal reflective layer,
wherein the primer layer is a layer obtained by performing either or both of heating process and light irradiation process on a layer containing a polymer having a polymerizable group and a functional group which interacts with a metal.

4. The film mirror according to claim 1,
wherein the metal reflective layer contains silver as a main component.

5. The film mirror according to claim 1, further comprising an adhesive layer between the diffusion preventive layer and the surface protection layer,
wherein the adhesive layer contains at least one kind of resin selected from the group consisting of epoxy-based resin, acryl-based resin, urethane-based resin, and silicone-based resin.

6. The film mirror according to claim 1 which is used for collecting solar light.

7. The film mirror according to claim 2, further comprising a primer layer between the resin substrate and the metal reflective layer,
wherein the primer layer is a layer obtained by performing either or both of heating process and light irradiation process on a layer containing a polymer having a polymerizable group and a functional group which interacts with a metal.

8. The film mirror according to claim 2,
wherein the metal reflective layer contains silver as a main component.

9. The film mirror according to claim 3,
wherein the metal reflective layer contains silver as a main component.

10. The film mirror according to claim 2, further comprising an adhesive layer between the diffusion preventive layer and the surface protection layer,
wherein the adhesive layer contains at least one kind of resin selected from the group consisting of epoxy-based resin, acryl-based resin, urethane-based resin, and silicone-based resin.

11. The film mirror according to claim 3, further comprising an adhesive layer between the diffusion preventive layer and the surface protection layer,
wherein the adhesive layer contains at least one kind of resin selected from the group consisting of epoxy-based resin, acryl-based resin, urethane-based resin, and silicone-based resin.

12. The film mirror according to claim 4, further comprising an adhesive layer between the diffusion preventive layer and the surface protection layer,
wherein the adhesive layer contains at least one kind of resin selected from the group consisting of epoxy-based resin, acryl-based resin, urethane-based resin, and silicone-based resin.

13. The film mirror according to claim 2 which is used for collecting solar light.

14. The film mirror according to claim 3 which is used for collecting solar light.

15. The film mirror according to claim 4 which is used for collecting solar light.

16. The film mirror according to claim 5 which is used for collecting solar light.
